(19) United States
(12) Patent Application Publication
(10) Pub. No.: US 2026/0220543 A1
(43) Pub. Date: Jul. 30, 2026

(54) COACHING OF ARTIFICIAL INTELLIGENCE AGENTS

(71) Applicant: System 2 AI Oy, Helsinki (FI)

(72) Inventors: Harri VALPOLA, Helsinki (FI); Alexander ILIN, Sarvvik (FI)

(21) Appl. No.: 19/434,128

(22) Filed: Dec. 29, 2025

(30) Foreign Application Priority Data
Jan. 30, 2025 (FI) 20255071

(51) Int. Cl. G06N 20/00

(52) U.S. Cl. CPC G06N 20/00

(57) ABSTRACT

A computer-implemented method for improving an operation of a first adaptive machine-learning model of an artificial intelligence agent by applying a second adaptive machine-learning model with at least one dataset comprising at least one sample is provided, the method comprises: inputting at least one hint as a part of at least one sample in the at least one dataset to the second adaptive machine-learning model; generating a target to an output of the first adaptive machine-learning model of the artificial intelligence agent by applying the at least one hint in an execution of the task with the second adaptive machine-learning model; and training the first adaptive machine-learning model by applying the target generated by the second adaptive machine-learning model. A computing system and a computer program are further provided.

### CROSS-REFERENCE TO RELATED APPLICATION

This application claims the benefit of and priority to Finland (FI) patent application No. 20255071 filed Jan. 30, 2025, the contents of which being incorporated by reference in their entirety herein.

### TECHNICAL FIELD

The disclosure generally relates to field of artificial intelligence. More particularly, the disclosure concerns so-called artificial intelligence (AI) agents.

### BACKGROUND

The rapid advancement of artificial intelligence has led to the development of AI agents powered by large language models (LLMs). Thanks to their remarkable reasoning and coding abilities, these agents are capable of executing real-world tasks by interacting with their environment, either through API calls or code execution. As the agents operate in the environment and make mistakes, they are often tuned by human experts to improve performance. Humans observe their behavior, analyze typical mistakes and provide extra hints and guidelines in the agent's prompt. Since it is difficult to predict which hints could be relevant at a particular step of task execution, a common approach is to include all possible guidance in the prompt. Over time, this leads to a long and convoluted prompt which the agent must analyze exhaustively at every action step. This scenario resembles a person with anterograde amnesia who relies on a system of handwritten notes to function sensibly. As the prompt grows, the agent's performance degrades due to the overwhelming amount of information it needs to process at each step.

In real-world applications, an aim of the AI agents is to evolve and continuously learn from their new experiences. However, relying on a system of notes, as is common in current approaches, is not a scalable solution.

Hence, there is a need to introduce approaches that enable the AI agents to improve in their task.

### SUMMARY

The following presents a simplified summary in order to provide basic understanding of some aspects of various embodiments of the present disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to a more detailed description of example embodiments of the disclosure.

An object of the disclosure is to present a computer-implemented method, a computing system and a computer program for improving an operation of an adaptive machine-learning model.

The objects of the disclosure are reached by a computer-implemented method, a computing system and a computer program as defined by the respective independent claims.

According to a first aspect, a computer-implemented method for improving an operation of a first adaptive machine-learning model of an artificial intelligence agent by applying a second adaptive machine-learning model with at least one dataset comprising at least one sample is provided, the method comprises:
inputting at least one hint as a part of at least one sample in the at least one dataset to the second adaptive machine-learning model, the at least one hint corresponding to data causing the artificial intelligence agent to improve in its task,
generating a target to an output of the first adaptive machine-learning model of the artificial intelligence agent by applying the at least one hint in an execution of the task with the second adaptive machine-learning model,
training the first adaptive machine-learning model by applying the target generated by the second adaptive machine-learning model.

The at least one hint may be generated through analysing an operation of the first adaptive machine-learning model of the artificial intelligence agent in its task.

For example, the at least one hint may define at least one instruction to improve the operation of the first adaptive machine-learning model of the artificial intelligence agent in its task.

Moreover, the at least one hint may be generated by at least one of: a human operator; a computing system.

The target to the output of the first adaptive machine-learning model of the artificial intelligence based agent may be defined with a training data for the first adaptive machine-learning model.

The second adaptive machine-learning model may be derived from the first adaptive machine-learning model. For example, the first adaptive machine-learning model and the second adaptive machine-learning model may be provided with same weights in an initial stage of improving the operation of the first adaptive machine-learning model. Still further, the second adaptive machine-learning model may be derived from the first adaptive machine-learning model by setting weights of the second adaptive machine-learning model to correspond to floating averages of the respective weights of the first adaptive machine-learning model.

Further, the first adaptive machine-learning model may be provided with one or more selected portions of the at least one hint input to the second adaptive machine-learning model during the improvement of the operation of the first adaptive machine-learning model of the artificial intelligence.

For example, the first adaptive machine-learning model and the second adaptive machine-learning model may be provided with a same prompt in the at least one sample of the at least one dataset.

The input of the first adaptive machine-learning model may be modified by one of: redefining the at least one hint in another manner; adding distractors to the prompt in the at least one sample of the at least dataset.

Still further, the first adaptive machine-learning model and the second adaptive machine-learning model may be requested, with the prompt, to reformulate a specific subject based on their current operative state.

Also, the artificial intelligence agent may be configured to generate instructions to a computer in relation to control an operation of the computer. For example, the instructions may be defined to generate sequential operations of the computer.

According to a second aspect, a computing system comprising a processor adapted to perform the method according to the first aspect as defined above.

According to a third aspect, a computer program comprising instructions which, when the program is executed by a computer, cause the computer to carry out the method according to the first aspect as defined above.

The expression “a number of” refers herein to any positive integer starting from one, e.g. to one, two, or three.

The expression “a plurality of” refers herein to any positive integer starting from two, e.g. to two, three, or four.

Various example and non-limiting embodiments of the disclosure both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the disclosure are illustrated by way of example, and not by way of limitation, in the figures of the accompanying drawings.

FIG. 1 illustrates schematically an iterative method according to an example.

FIG. 2 illustrates schematically a computer-implemented method according to an example.

FIG. 3 illustrates schematically a computing system as a block illustration according to an example.

FIG. 4 illustrates schematically a sequential coaching in task execution according to an example.

FIGS. 5a and 5b illustrate schematically training procedures according to examples.

FIG. 6 illustrates schematically a computing system according to an example.

### DETAILED DESCRIPTION

The specific examples provided in the description given below should not be construed as limiting the scope and/or the applicability of the appended claims. Lists and groups of examples provided in the description given below are not exhaustive unless otherwise explicitly stated.

In accordance with the present disclosure, a computer-implemented method for coaching of an artificial intelligence (AI) agent by incorporating feedback e.g. from a user (cf. human expert) is introduced. A knowledge comes as an additional information given in a form of one or more hints provided as the feedback and included in prompts that direct the AI agent to perform in an improved manner, i.e. to outperform, on a given set of tasks. The hints are internalized into the weights of an adaptive machine-learning model of an artificial intelligence agent, such as an LLM, through a training procedure in accordance with the present disclosure. The coaching process according to the disclosure is iterative: after every round of training, the behavior of the trained agent is observed e.g. by a user and additional hints, aka. additional information, is provided that is relevant at specific steps of the task execution, and the additional information, i.e. hints, are further internalized into the weights, and the coaching rounds continue. This iterative approach allows the AI agent to progressively refine its understanding and execution of tasks, reducing reliance on extensive prompts.

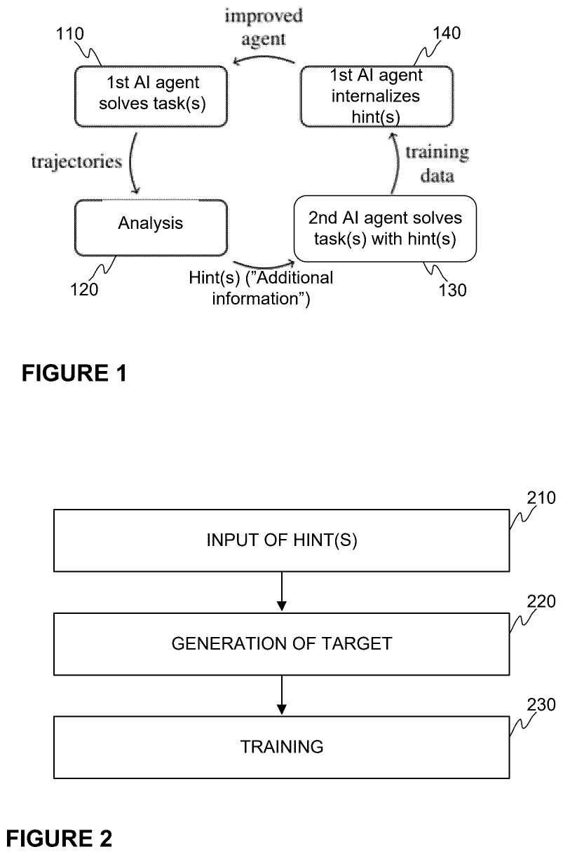

FIG. 1 illustrates schematically at least some aspects in relation to the present disclosure according to an embodiment in a fundamental manner. In other words, an iterative method is shown to improve an operation of an adaptive machine learning (ML) model of an AI agent wherein the adaptive machine learning model primarily refers here to so-called large language models (LLMs), like GPT4 or similar. The iterative method may be described by starting from step 110 wherein the AI agent, i.e. a first adaptive machine-learning model of the AI agent (“student”) is requested to solve one or more tasks without providing any additional hints into it. In other words, the first adaptive machine-learning model performs the tasks as it is. The perform of the task(s) generates data descriptive of an execution of the task(s), or of a success in the execution of the task(s) and it is referred as a trajectory, trajectories (cf. FIG. 1). The trajectory may e.g. be expressed as a sample consisting at least from two portions: a prompt (cf. state) and a response of the ML model (cf. action). Advantageously, both of these are so-called token sequences, like text or any other sequential data. The operation of the first adaptive machine-learning model of the AI agent is analysed 120 in a predefined manner. This may refer to an operation wherein a number of predefined criteria are applied in the analysis and at least one aim is to find possible mistakes performed by the first adaptive machine-learning model in its task. The analysis 120 may be performed by a human operator or by a computing system configured to perform the analysis by applying the predefined criteria. In response to the analysis the party performing the analysis may be configured to provide, as an input, hint(s) to be taken into account in performing the task(s) another AI agent, i.e. a second adaptive machine-learning model of the AI agent adapted to operate in a role of a teacher, is configured to perform. The hint(s) may take various forms, such as in-context examples of tool usage by means of which the task is performed, step-by-step task-solving strategies, and inner monologue recommendations. Thus, the AI agent may be instructed to solve 130 its task(s) by modifying its operation based on the hint(s) provided to it. Thus, the provision of the hint(s) guides, i.e. causes, the AI agent to perform in an improved manner, i.e. to outperform, and it may generate a target to an output of the first adaptive machine-learning (ML) model. The target may e.g. be defined in a form of a training data that takes the first adaptive ML model to operate in an improved manner when trained with the training data. The training data may be understood as a dataset comprising one or more samples, wherein each sample may correspond to a trajectory wherein the trajectory may comprise a prompt, one or more hints and an action. In other words, the step 140 in FIG. 1 refers to an operation in which the first adaptive ML model is modified through training to internalize the hint(s) in its operation. As a result, the improved AI agent whose adaptive ML model was trained in the step 140 is taken to a role in which it is made to solve the tasks again (cf. step 110 in FIG. 1) and the improvement of the operation of the adaptive model may be iteratively continued as described. For avoidance of doubt, it is worthwhile to mention that the trajectories may also be generated even with a third adaptive ML model or even manually.

The approach described in the foregoing description is schematically illustrated in another manner in FIG. 2 wherein a computer-implemented method for improving an operation of a first adaptive machine-learning model of an artificial intelligence agent by applying a second adaptive machine-learning model is shown.

In accordance with the method hint(s) is input 210 to the second adaptive machine-learning model wherein the hint(s) corresponding to data causing by instructing the artificial intelligence agent to perform in an improved manner, i.e. to outperform, in its task, or tasks. As described, the hint(s) may be generated through analysing 120 an operation of the first adaptive machine-learning model of the artificial intelligence agent in its task. For example, the hint(s) may define at least one instruction to improve the operation of the first adaptive machine-learning model of the artificial intelligence agent in its task.

In response to the step 210 a target to an output of the first adaptive machine-learning model of the artificial intelligence agent is generated 220 by applying the hint(s) in an execution of the task with the second adaptive machine-learning model.

In response to the generation of the target the first adaptive machine-learning model may be trained 230 by applying the target generated by the second adaptive machine-learning model. Thus, the data representing the target may correspond to data that may be applied as a training data, or training dataset, for the first adaptive machine-learning model.

The computer-implemented method is executable by a computing system, such as a data processing apparatus like a computer device. The computing system may execute a software code that implements the AI agent whose operation is improved in the described manner. Thus, the computing system manages the first adaptive machine-learning model and the second adaptive machine-learning model of the AI agent. It may also be configured to replace the second adaptive machine-learning model with the first adaptive machine-learning model in response to the training of the first ML model in the described manner. Thus, the second adaptive ML model may be considered as a derivative of the first ML model. It may be considered that the second adaptive ML model and specifically its weights are formed with statistical mathematics from the weights of the first adaptive ML model. For example, the weights of the second adaptive ML model may be a floating average of the weights of the first adaptive ML model.

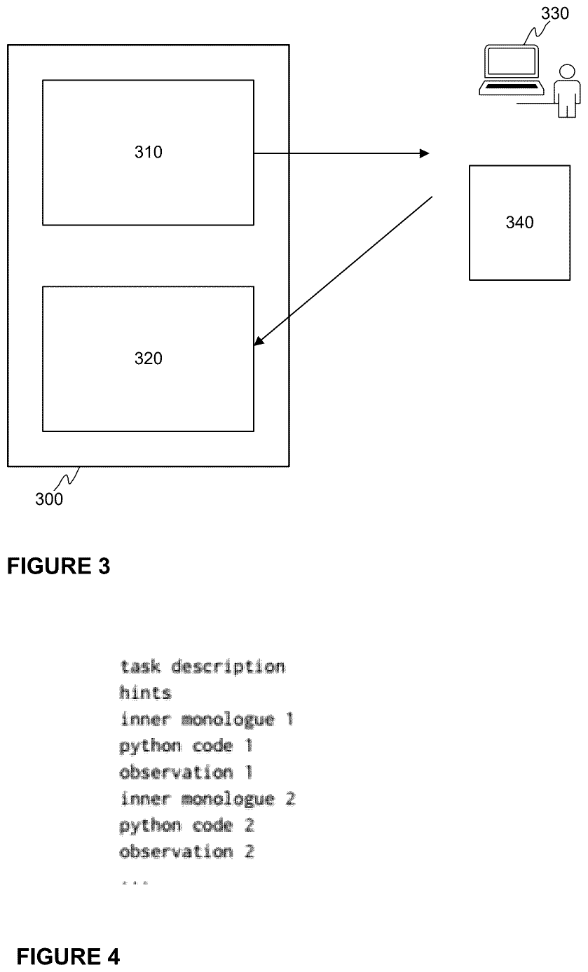

FIG. 3 illustrates schematically a computing system 300 wherein the first adaptive ML model 310 and the second adaptive ML model 320 are executed and the first and the second adaptive ML models are interacting in the described manner. Furthermore, FIG. 3 illustrates also schematically entities that may be configured to generate, or at least be involved in the generation, the additional information. For example, a human operator may be arranged to supervise the operation of the first adaptive ML model 310 in its task and to generate the hint(s) to guide the improvement of the operation of the first adaptive ML model 310 in the described manner. Alternatively or in addition, a computing system may be configured to perform the generation of the additional information.

In order to improve the method as described to coach the respective adaptive machine-learning model of the artificial intelligence the hint(s) may comprise generalization mechanisms. In the following at least some mechanisms are described in order to improve the coaching so as to make the adaptive machine-learning model under coaching to have an improved generalization ability:
“Input expansion”: Add distractors to the prompt of the first adaptive machine-learning model 310 (i.e. the “student”). Whereas hints aim at guiding the second adaptive machine-learning model 320 (i.e. the “teacher”) to generate better actions, the distractors make the task of the first adaptive machine-learning model 310 harder. This prepares the student, i.e. the first adaptive machine-learning model 310, to generate the correct actions despite other confounding factors.
“Input expansion”: Reword the prompt for either or both the second adaptive machine-learning model 320 (i.e. the “teacher”) and the first adaptive machine-learning model 310 (i.e. the “student”). This allows the first adaptive machine-learning model 310 to recognize similar situations and respond appropriately to them. Rewording can be done efficiently using LLMs.
“Output expansion”: Include an instruction for the second adaptive machine-learning model 320 (i.e. the “teacher”) and maybe for the first adaptive machine-learning model 310 (i.e. the “student”) to reword the answers. This boosts the ability of the first adaptive machine-learning model 310 to learn the semantic meaning of the instructions and actions rather than memorise sequences of tokens on a surface level.

There are some issues that need to be taken into account in the coaching of the adaptive machine-learning model as described. Training of an adaptive machine-learning model with new data can sometimes lead to degraded performance on old tasks. This can be prevented or at least mitigated by doing the following:
When one or more rounds of iterative improvement according to FIG. 1 have been completed, include some old training data from previous rounds when compiling the new training dataset.
“Conservative samples”: Since there is now a teacher model, i.e. the second adaptive machine-learning model 320, a set of unrelated tasks may be generated and exactly the same input may be given for both the second adaptive machine-learning model 320 (i.e. the “teacher”) and the second adaptive machine-learning model 310 (i.e. the “student”) (i.e., no hint(s) for the second adaptive machine-learning model 320 or the same hint(s) for both) and train the first adaptive machine-learning model 310 to output exactly the same logits. The second adaptive machine-learning model 320 is an earlier checkpoint which has not yet been trained on the new data.

Next further aspects and insight is given to the present disclosure through describing it in a specific context. For avoidance of doubt it is worthwhile to mention that the term student in the following paragraphs and/or related figures refers to the first adaptive machine-learning model 310 and the term “teacher” refers to the second adaptive machine-learning model 320 as used in at least some portions of the description of the present disclosure. The agent architecture according to an embodiment may be as described in the following.

The agent has a common ReAct architecture. Given a task description and an initial set of hints, the agent generates actions consisting of two parts: a reasoning trace and an executable code snippet (see FIG. 4). The agent's prompt consists of sections, each enclosed within XML-style tags. For example, a reasoning trace (inner monologue) section follows the structure <inner monologue> . . . </inner monologue>. To enhance compliance with the correct response format, the expected structure in a separate message is outlined immediately before requesting an inner monologue or code response. In addition, the response with the corresponding opening XML tag is initiated. The executable part of the agents' actions is defined as Python code. The agent receives the execution outputs, including the content of the standard output and standard error (stderr), as its next observation.

The agent has access to a set of tools, which it invokes as Python functions within its code actions. During the first round of training, these tools are documented in the initial hints section. While executing individual tasks may require using a specific subset of tools, every task execution must be finalized by calling the function complete task (report, answer), through which the agent submits the final report and the requested answer. After the first round of training, the agent internalizes the knowledge of the tools and the tool descriptions are removed from the hints.

In the following a training of the AI agent is described wherein the term “algorithm” shall be understood as an implementation of the method according to at least one embodiment of the disclosure.

In other words, an iterative algorithm to coach AI agents to master their tasks is now presented.

In the Round 1 initial hints on tools and other instructions for novel tasks are internalized as discussed in the following.

Prompt engineering for initial hints: Initially, an AI agent is tasked with solving a set of training tasks using minimal guidelines, which include only tool descriptions and formatting instructions. During this phase, we observe the agent's behavior, identify common mistakes, and introduce additional guidance and hints to improve decision-making in difficult scenarios. The hints may take various forms, such as in-context examples of tool usage, step-by-step task-solving strategies, and inner monologue recommendations. If the agent performs different task types, only tips relevant to the current task are provided, that is the hints may be task-dependent. This phase effectively serves as prompt engineering, where the agent's prompt is iteratively refined to elicit the desired behavior. As with any prompt engineering approach, these refinements may generalize across different large language models (LLMs) but might require additional tuning when applied to different models.

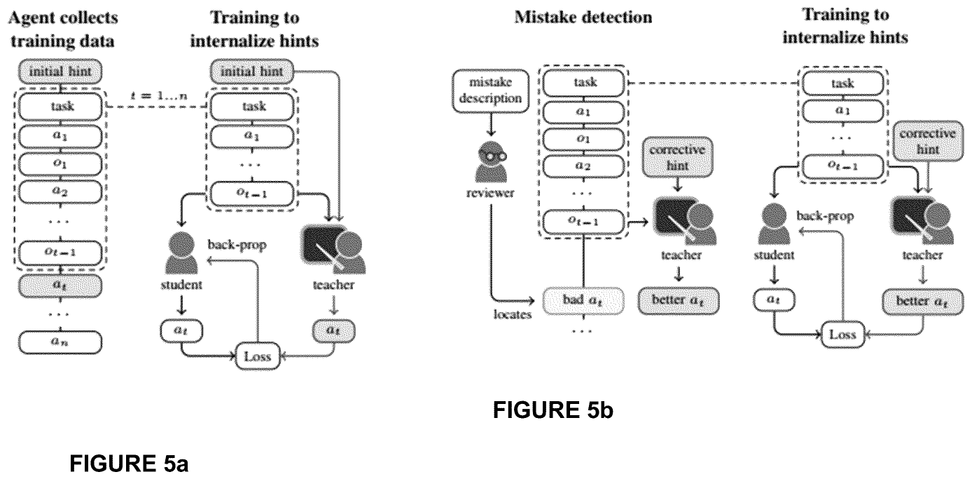

Internalizing initial hints: Once the initial hints, denoted by h₁(s), have been optimized, training trajectories generated by the agent while following h₁(s) are sampled, and these are collected into a dataset of state-action-hint triplets, [symbol] ₁={(s, a, h₁(s)} (see FIG. 5a). Each state s in [symbol] ₁ consists of a sequence of observations and actions: sₜ=(o₀, a₁, o₁, . . . , oₜ₋₁) within the same trajectory, where o₀ denotes the task description. The action at taken in the state sₜ includes an inner monologue and an executable Python code. The LLM in use as the agent is a standard instruction-tuned LLM and its parameters are denoted by θ₁.

Next, the parameters of the LLM are updated

$${θ}_{2} ← {θ}_{1} + {Δθ}_{1} ,$$

such that the new model θ₂ acts if it had access to the full hints h₁(s), but without needing it explicitly in each prompt: Thus, the model internalizes the hints h₁(s) in its weights to achieve

$${π}_{θ} 2 ( a \vert s ) \approx {π}_{θ 1} ( a \vert s , {h}_{1} ( s ) , ∀ ( a , s ) ) ∈ {𝒟}_{1} .$$

This step is performed by using the context distillation approach. The new model θ₂ is constructed by adding a LoRA adapter Δθ₁ to the current weights θ₁. The training set [symbol] ₁ is used to train the new model θ₂, which is called as the student, to mimic the outputs of the current model θ₁, the teacher, without seeing the hints h₁(s) in its prompt (see FIG. 5a).

Different loss functions were experimented for this training procedure:
1. KL: Minimize the KL divergence between the student's output distribution for each token in the action sequences (including reasoning and Python code) and that of the teacher's, for actions in the training set trajectories.
2. KL, success only: Same as option 1 but use only trajectories in which the teacher returns the correct answer.
3. CE: Select only successful trajectories and use the tokens produced by the teacher as the targets for the student to minimize the cross-entropy loss. Training with cross-entropy on the full set of trajectories would not be desirable as the student should not learn to copy the teacher's mistakes.

While the agent is trained to improve its policy on a set of specific tasks, measures to prevent degradation of its general skills such as paying attention to its prompt are taken. Therefore, instead of dropping out the initial hints h₁(s) completely from the student's prompt, this is done with probability p, applied separately to each section of the hints h₁(s), where p is a hyperparameter, empirically set to 0.9.

In the Round 2, Corrective hints are internalized as discussed in the following.

Although Round 1 typically yields an agent that can solve tasks without any task-specific hints in its prompt, the agent often exhibits suboptimal behavior in some situations and makes mistakes. Such failure cases can be difficult to anticipate or exhaustively cover in the initial hints, so a mechanism to correct for remaining issues in subsequent rounds of training is proposed. The idea is to observe the executed traces of the trained agent, identify what kind of mistakes caused the failures, and provide corrective hints to improve the agent's policy to tackle similar difficult situations in the future.

This round is started by sampling trajectories with the current agent θᵢ on the same set of tasks as considered in previous rounds. The agent does not have any hints in the prompt at this stage. Then, the trajectories are analyzed and filters that automatically detect problematic situations of certain kinds are designed (see FIG. 5b). In FIG. 5b, filtering is represented by the Reviewer, which inspects the collected trajectories. The filters can be implemented as a script that detects certain actions or outputs (e.g., through string matching or checks on a generated program's abstract syntax tree) or they can involve calling an LLM to detect a problematic action given the description of a mistake. It is possible to design multiple filters that detect mistakes of specific types. As a result of the filtering stage, a set of states Sᵢ={s} in which the current agent makes mistakes is collected, where i=2, . . . , I denotes the index of the round.

Next, the agent's behavior is tried to be improved by providing corrective hints hᵢ(s) for states s∈Sᵢ, such that hᵢ(s) correct the agent's action in the problematic states. Note that the hint hᵢ(s) depends on state s to emphasize that the hints are generally state-specific.

Then, the hints hᵢ(s) are inserted at the end of the LLM prompt, after the corresponding state s, and sample corrected actions conditioned on the corrective hints:

$$a \sim {π}_{θ i} ( a \vert s , {h}_{1} ( s ) ) .$$

The actions are added to a new dataset of state-action-hint triplets [symbol] ᵢ={(s, a, hᵢ(s)} used in the next round of training. Note that, as the number of detected mistakes can be small, it usually makes sense to sample multiple actions from the same state s to increase the size and diversity of data in [symbol] ᵢ. It is also beneficial to balance the dataset [symbol] ᵢ such that different types of mistakes and tasks are well represented.

After that, we perform the next round of training to internalize the corrective hints hᵢ(s). As in Round 1, training is implemented by adding a new LoRA adapter to the LLM weights

$${θ}_{i + l} = {θ}_{i} + {Δθ}_{i}$$

and tuning the student model θᵢ₊₁ to mimic responses of the teacher empowered by hints hᵢ(s).

In practical scenarios, this round can be repeated multiple times to refine the agent's policy and correct any remaining mistakes. Additionally, if the agent needs to learn a new task that requires a different set of tools and an alternative execution strategy, Round 1 can be revisited to internalize guidance for this novel task. The proposed training procedure in Algorithm 1 is formally presented below:

Algorithm 1 Proposed training algorithm

| | |
|---|---|
| 1: | Initialize θ₁ ← weights of the agent LLM. |
| 2: | for i = 1 to I do |
| 3: | Sample trajectories from π_{θ}_{ᵢ} (a\|s). |
| 4: | if i == 1 then |
| 5: | Design hints hᵢ(s) to improve π_{θ}_{ᵢ} (a\|s). |
| 6: | Sample trajectories from π_{θ}_{ᵢ} (a\|s, hᵢ(s)) to get |
| | dataset [symbol] ᵢ = {(s, a, hᵢ(s))}. |
| 7: | else |
| 8: | Filter states [symbol] ᵢ = {s} in which π_{θ}_{ᵢ} (a\|s) makes |
| | mistakes. |
| 9: | Design hints hᵢ(s) to improve π_{θ}_{ᵢ} (a\|s) for states |
| | s ∈ [symbol] ᵢ. |
| 10: | Sample actions a ~ π_{θ}_{ᵢ} (a\|s, hᵢ(s)) for states |
| | s ∈ [symbol] ᵢ to get dataset [symbol] ᵢ = {(s, a, hᵢ(s))}. |
| 11: | end if |
| 12: | Balance [symbol] ᵢ to make sure that different types of |
| | tasks/mistakes are well represented. |
| 13: | Using a LoRA adapter Δθᵢ, distill hints hᵢ(s) to |
| | weights θᵢ₊₁ = θᵢ + Δθᵢ, to satisfy |
| | π_{θ}_{ᵢ₊₁} (a\|s) ≈ π_{θ}_{ᵢ}(a\|s, hᵢ(s)) , ∀(s, a, hᵢ(s)) ∈ [symbol] . |
| 14: | end for |
| 15: | return LLM weights θ_{I}. |

### Connection to Imitation Learning

The proposed training algorithm is closely related to imitation learning, particularly the DAgger (Dataset Aggregation) algorithm. DAgger is designed to address the compounding error problem in behavior cloning, which arises when the learned policy encounters states not present in the expert demonstrations. When executing the policy, the learner inevitably makes mistakes, leading to deviations from the expert trajectory and entering unfamiliar states where it lacks proper supervision. To mitigate this issue, Dagger iteratively improves the policy by alternating between executing the current learned policy and querying an expert for corrective actions in the states the policy visits. These newly labeled states are aggregated with the original expert dataset, and the policy is retrained on this expanding dataset to improve robustness. By progressively incorporating expert feedback on states induced by the learner's mistakes, DAgger ensures better generalization and resilience to distribution shift.

In the proposed algorithm, the role of the expert is played by an LLM empowered by hints designed by a human (the teacher in FIGS. 5a and 5b). This approach eliminates the need for explicit expert demonstrations, which can be time-consuming and challenging to obtain. Instead, hints provide a lightweight yet effective way to generate reasonable target signals across the various states encountered during task execution. Furthermore, hints offer an additional advantage: they provide access to the full policy of the expert, represented as an output distribution over tokens, rather than just a single demonstration. This richer training signal contains significantly more information than traditional expert demonstrations.

Similar to DAgger, the algorithm iteratively trains the learner's policy, observes the mistakes made by the learner after each training round, and corrects those mistakes using corrective hints that serve as expert supervision. This iterative process ensures continuous improvement, leveraging the strengths of human-designed hints and the flexibility of LLMs to work in dynamic and complex environments.

In the following it is provided aspects that are related to the present disclosure and may describe embodiments of the present disclosure at least in part.

Reasoning with language models: The disclosure may be considered to be related to efforts for improving reasoning in language models. These approaches typically seek to decompose reasoning tasks into unit steps so that the deployed computation can scale with the complexity of the task.

Generating code as a structured format to support reasoning is another popular approach. To improve reasoning through experience, a line of work has elicited self-critiques from the model itself by prompting it to reflect on its past behavior. This is similar in spirit to the stage 2 training, but is bounded by the agent's ability to spot its own mistakes and self-correct, a known limitation; we instead leverage efficient human feedback for more accurate corrections.

Human feedback in LLM training: Multiple frameworks for incorporating human feedback in LLM training have been proposed. Specific forms of human feedback used in prior work include ranking several model answers, and providing a list of ground rules a model should not break.

Interactive LLM frameworks: Several prior works embed LLMs in interactive environments. The most common approach has been to leverage in-context learning to document the list of available tools and their use, and concatenate agent history to the current prompt, while keeping the underlying model itself unchanged. However, LLMs trained for one-turn instruction following are highly suboptimal for staying on task in multi-step task execution, as is shown in the forthcoming description discussing experimental outcomes in relation to the present disclosure. For proprietary models that cannot be improved through training, some works aim to remedy these limitations by instead optimizing the agent framework, such as the available tools, or use Retrieval Augmented Generation (RAG) systems.

Supervised fine-tuning for interactive settings: In addition to prompting, supervised fine-tuning (SFT) is a second dominant approach to teaching pre-trained LLMs new skills. SFT depends on having access to high-quality, usually human-generated data. However, such data collection is difficult to scale due to its high cost. This is especially the case for multi-turn agent trajectories, and using labeled examples as the primary source of training data ultimately caps performance at the skill level of the annotators. For tasks with known and easily verifiable answers, synthetic trajectories from the agent itself can be filtered to produce training data. This strategy is also explored as an ablation to the distillation objective.

Knowledge Distillation: Distillation methods are an alternative way to teach an agent new knowledge and capabilities. In typical knowledge distillation settings, the outputs of a larger or otherwise more computationally expensive model (the teacher) are used as targets for a smaller model (the student) to transfer knowledge or capabilities. This approach is only viable if a more capable model already exists. Moreover, it is not always clear if a smaller model has the representational capacity to accurately model the process the larger model uses to generate its outputs, without resorting to memorizing spurious correlations in the training data.

In prompt distillation, in contrast, the same model is used as teacher and student, but with different inputs: the teacher model has access to additional context not shown to the student. At least some embodiments of the present disclosure are the first ones to extend this approach to training LLM agents.

The method according to the disclosure is also tested with experiments as described in the following:

Task set: In the experiments, the agent is trained to master tasks from the ToolQA benchmark. ToolQA is a benchmark for evaluating an agent's ability to retrieve information, use tools, and answer questions. It consists of question answering tasks that require the agent to fetch relevant data from external databases in various formats, such as text documents, graphs, or tabular databases. Examples of tasks and the steps required to solve them are presented in the table below.

| Group | Question template | Solution steps |
|---|---|---|
| Yelp | What is the postal code of [business] | 1. Load Yelp database. 2. Filter by [business], [city] and [state]. |
| | in [city], [state]? | 3. Fetch and return the postal code column. |
| Yelp | Which [business category] has the | 1. Load Yelp database. 2. Filter by [city] and [state]. 3. Select rows |
| | highest review count in [city], | for which the category column includes [business category]. |
| | [state]? | 4. Fetch the review count column. 5. Use the index of the max review |
| | | count to select and return the name of the business. |
| Flights | How many extra minutes did the | 1. Load flights database. 2. Separate [flight ID] into [airline ID] |
| | [flight ID] flight take from | and [flight number]. 3. Filter by [airline ID], [flight number], |
| | [departure] to [destination] on | [departure], [destination] and [date]. 4. Fetch departure delay and |
| | [date]? | arrival delay columns and return arrival delay - departure delay. |
| Flights | What is the total number of flights | 1. Load flights database. 2. Filter by [airline] and [date]. 3. Count |
| | operated by [airline] on [date]? | and return the number of rows. |

Six groups of tasks from the ToolQA benchmark are considered: DBLP, Agenda, Yelp, Airbnb, Flight, and Coffee. The agent has access to a total of 9 tools to perform these tasks, however solving tasks from a particular task group requires a smaller number of tools (two for Agenda, five for DBLP and four for the rest). The tools can be used by calling corresponding Python functions. In the experiments, 1,076 tasks with 99 distinct question templates were selected, examples of which are shown in table above. An agent's performance is assessed by measuring the success rate through exact string matches between its returned and correct answers.

The dataset is divided into two settings to evaluate the agent's performance under different conditions:
1. In the Within-Template Split, tasks with the same question template are randomly divided into training, validation, and test sets. This ensures that all task types are represented in all splits, preventing any distribution shift. This results in 655, 99, and 342 tasks for training, validation, and testing, respectively.
2. In the Cross-Template Split, question templates are divided into two parts: one part is used for training and validation, while the other part is reserved for testing. This setup evaluates the agent's ability to generalize to unseen question templates, introducing a distribution shift. This split results in 665, 67, and 364 tasks for training, validation, and testing, respectively.

The ultimate goal is to design an agent capable of answering questions from the six ToolQA groups without being explicitly informed about which group a particular question belongs to. Llama-3.1-70B-Instruct is used as the LLM engine of our agent. In all results tables, the average success rates computed on the test set tasks are reported. The specific data split is explicitly mentioned in the table captions. The subscripted number represents the standard error, calculated across three trials.

### Baseline Agents

First, the performance of the Llama-based agent on the ToolQA tasks in a setting where the agent receives only hints relevant to solving a given task is evaluated, meaning it has access exclusively to task-specific hints in its prompt. The results of this evaluation (see the table below) indicate that providing only the documentation of task-specific tools as guidance is insufficient for achieving strong performance, yielding a relatively low average success rate of 66.1%. However, when the hints with additional task-specific explanations and examples on how to use the tools (together referred to as best practices) are supplemented, the agent's performance improves significantly, achieving a high success rate of 96.9%. This performance level gives an estimate of the upper bound of the base Llama's performance on the ToolQA tasks.

| Hints in prompt | DBLP | Agenda | Yelp | Airbnb | Flight | Coffee | Avg. |
|---|---|---|---|---|---|---|---|
| task-specific tools | 90.4_{2.0} | 56.3 [symbol] | 64.4_{1.0} | 50.3 [symbol] | 49.4 [symbol] | 85.4_{2.0} | 66.1 [symbol] |
| task-specific tools | 93.2_{1.0} | 100.0_{0.0} | 97.2 [symbol] | 96.7_{0.7} | 96.1 [symbol] | 98.1_{1.2} | 96.9_{0.4} |
| and best practices | | | | | | | |

[symbol]

indicates data missing or illegible when filed

Next, the primary scenario of interest is on focus, where the agent must answer questions from any of the six task groups without being informed of the task type. To address this, the task-specific hints from all task types are combined into a single prompt and tune these combined hints on tasks from the training set. This approach results in a significant degradation in performance, dropping the average success rate from 96.9% to 88.4% (see the table below). We refer to this phenomenon as the Memento effect. Notably, even larger models like DeepSeek V3 and GPT-4o (version gpt-4o-2024-08-06) struggle with the long and complicated prompt. While GPT-4o achieves the best performance among these models at 92.8%, this result is still worse than Llama's performance when the hints were tailored to individual task types. Importantly, the combined hints were adjusted separately for each model, as they may not generalize well across different models. For cost reasons, we consider one trial for GPT-4o, and 3 trials for all other models.

| Agent | Hints in prompt | DBLP | Agenda | Yelp | Airbnb | Flight | Coffee | Avg. |
|---|---|---|---|---|---|---|---|---|
| Llama-3.1-70B | combined tools | 61.0 [symbol] | 59.5 [symbol] | 61.0_{0.9} | 51.6 [symbol] | 49.4 [symbol] | 83.1 [symbol] | 61.0 [symbol] |
| Llama-3.1-70B | combined tools | 96.0 [symbol] | 73.8 [symbol] | 91.0_{1.1} | 88.2_{2.0} | 88.3 [symbol] | 93.0 [symbol] | 88.4_{0.7} |
| DeepSeek-V3 | and best practices | 89.8_{2.0} | 73.0 [symbol] | 87.6 [symbol] | 83.0 [symbol] | 92.8_{2.2} | 98.6 [symbol] | 87.5 [symbol] |
| GPT-4o | | 98.3 | 76.2 | 96.6 | 92.2 | 93.3 | 100.0 | 92.8 |
| MNM round 1 (ours) | — | 92.1_{2.0} | 94.4 [symbol] | 84.7 [symbol] | 89.5_{2.0} | 92.2 [symbol] | 97.7_{0.9} | 91.8_{0.7} |
| MNM round 2 (ours) | | 97.7_{1.1} | 92.9 [symbol] | 94.9_{1.0} | 96.1_{1.1} | 93.3_{1.0} | 99.5 [symbol] | 95.7_{0.4} |
| MNM round 3 (ours) | | 98.9 [symbol] | 96.0 [symbol] | 98.9_{1.1} | 96.1_{0.0} | 98.3_{0.1} | 99.5 [symbol] | 97.9 [symbol] |

[symbol]

indicates data missing or illegible when filed

Next, coaching the Llama-based agent is discussed.

### Round 1

Next, the first round of training is conducted for the Llama-based agent. To collect training data, the agent is run using the task-specific hints described in the foregoing description. By solving each training task three times, 7,107 state-action-hint triplets are compiled, which form the training set [symbol] ₁={(s, a, h₁(s)}.

The student model is constructed by augmenting the base Llama model with a LoRA of rank 128. The student model is then trained by performing 1,778 updates, where each update involves randomly sampling a batch of size 8 from the training set. Following this first round of training, the success rate of the trained agent, which no longer requires any guidance in the prompt, reaches 91.8%. While this performance falls short of the teacher model's 96.9%, it surpasses the agents using the combined prompt for Llama and DeepSeek V3 and closely approaches the performance of GPT-4o.

### Round 2

After the first round of training, the agent exhibited several typical mistakes, including forgetting to print values for inspection, incorrectly post-processing data extracted from the database, opting for unnecessary programmatic solutions, failing to remove duplicate values, reasoning incorrectly about retrieved documents, and providing incorrect tool arguments. To address these issues, we conducted a second round of training.

To collect the data for the second round, each training task is again solved three times using the latest version of the trained agent without any hints in the prompt. To fix typical mistakes, 14 filters leveraging the LLM-as-a-judge approach are designed to detect problematic steps in the agent's reasoning and execution.

Once the erroneous steps are identified, a set of mistake-dependent hints is constructed, denoted as h₂(s), which are inserted into the agent's prompt to guide it toward improved actions. Through this process, a total of 208 state action-hint triplets are collected, derived from 99 unique states where multiple actions were sampled per state. Of these, 184 samples are used to form the training set [symbol] ₂={(s, a, h₂(s))}, while 24 samples are reserved for tracking validation loss during training.

To refine the agent further, a new student model is constructed by adding an new LoRA adapter of rank 128 to the latest trained model and updating its parameters 138 times, using randomly sampled batches of size 8 from [symbol] ₂. This training step enables the agent to produce improved actions without requiring explicit hints in the prompt.

As a result of this second training round, the average success rate of the trained agent without any guidance reaches 95.7% (see the previous table). Notably, the trained agent, despite operating with a clean prompt and without any external guidance, surpasses the performance of GPT-4o, demonstrating the effectiveness of our training methodology.

### Round 3

After Round 2, an analysis of the typical mistakes made by the agent was again conducted, identifying several recurring issues. These included failing to print values for inspection, applying incorrect post-processing methods to data extracted from the database, misinterpreting the meaning of certain columns, and not adhering precisely to the task descriptions when referencing names.

To further refine the agent's performance, the agent was run on the training tasks three times for each task and 18 filters were designed to detect different types of mistakes. This process identified 68 unique states with errors, for which new hints h₃(s) were designed which corrected the agent's behavior. By sampling multiple actions from these states, 120 state-action-hint triplets were created. However, this dataset posed two potential challenges: 1) the relatively small number of unique states, as the agent had already improved significantly; 2) an imbalance in task representation, since the agent performed some task types more accurately than others.

To prevent performance degradation on task types that were underrepresented in this dataset, full trajectories were also collected using the trained agent with the hints designed in Round 1. A training set [symbol] ₃ was created by combining the 120 corrected transitions with 69 full trajectories from this round, ensuring that all task types were well represented. The final dataset used in this round comprised 359 training samples.

A new adapter was then added and the updated model was trained for 270 updates with batch sizes of 8. As a result, the trained agent achieved an average success rate of 97.9%, significantly surpassing the performance of all prompted agents. Beyond improved success rates, the trained agent also demonstrated notable advantages in inference efficiency, achieving a more than 4× increase in inference speed compared to the untrained Llama agent while also reducing inference costs due to a shorter context length (see the table below).

TABLE 5
The average number of tokens used to solve a task.

| Agent | Input tokens | Output tokens |
|---|---|---|
| DeepSeek-V3 | 59,056 | 552 |
| GPT-4o | 77,736 | 527 |
| Llama-3.1-70B | 74,950 | 449 |
| MNM round 3 (ours) | 5,564 | 460 |

Next, performance on standard benchmarks is discussed.

Although significant improvement was observed in the trained agents across ToolQA tasks, the domain of interest, the aim is to train agents that simultaneously exhibit little performance degradation in other domains. The agents were therefore evaluated on HumanEval and GSM8K, standard benchmarks for coding and for mathematical reasoning, respectively. The agents actually improve on HumanEval relative to the base Llama, likely because the agent framework also involves coding.

Next, ablation is discussed: loss functions and data filtering.

The effect of the choice of loss function and Round 1 training data in an ablation study is quantified. When training with KL divergence, filtering the data to only successful trajectories was found to slightly hurt performance, as the student does not receive any feedback on how to adjust its behavior in difficult states and edge cases. In the ablation, cross-entropy (CE) on success-only trajectories to achieve comparable or slightly higher performance to KL divergence on all trajectories was found, but result in a less general agent that was more difficult to improve in further training rounds. After Rounds 2 and 3, the agent trained with KL divergence on all trajectories outperforms the CE alternative.

The present disclosure is applicable in various contexts and the following examples provide some insight to a way of applying of the present disclosure:
AI-Powered Personal Assistant with On-the-Job Learning
   Use Case: A digital assistant, the AI agent, that learns user preferences, workflows, and communication styles while assisting with scheduling, drafting emails, and summarizing documents.
   Architecture: The AI agent comprises a large language model (LLM) and supporting software which compiles the prompt following the structure in FIG. 4 and executes the Python code generated by the LLM in response to the prompt, looping until the task is completed. The base LLM is Llama-3.1-70B-Instruct. The task description given to the agent is derived from user input augmented with information from the user profile (e.g., authentication tokens needed for accessing the user's calendar).
   Initial Hints: The initial hints for the agent consist of general instruction about how to solve the tasks using the Python cells, formatting instructions (e.g., inner monologues and Python code are expected to be wrapped inside specific XML tags), documentation of the tools available for the agent (the tools in this case are Python functions that are available in the namespace of the Python interpreter executing the code generated by the LLM) and generic advice about the best practices for executing workflows (e.g., the agent should always verify the correctness of its results before submitting them as the outputs).
   Round 1 Dataset: 3,734 samples from task execution are collected using 30 hand-crafted task descriptions (e.g., “Schedule a video call with Mary Smith next Friday at 3 μm”) which are augmented to 150 distinct task description using a separate LLM (GPT-4o). Five rollouts of each distinct task were collected using a temperature 1.2 to generate variability. Each task execution took between 3 to 11 steps, resulting in 3,734 steps in total. Each step was used as a training sample. In order to prevent the training from degrading the model performance on other tasks, a random sample of 500 steps was added to the training data from HumanEval. For these samples, the teacher and student received exactly the same prompts. This helps the student keep paying attention to any and all instructions.
   Round 1 Training: The teacher (i.e. the second adaptive machine learning model) and the student (i.e. the first adaptive machine learning model) are initialized to the weight values of the base LLM. An additional trainable LoRA adapter with rank 256 is added to the student model (initialized to correspond to zero change to weights) while all other weights are kept fixed. Dropout probability of 0.9 is used for each section of the hints separately and the LoRA adapter is trained for 20 epochs.
   Round 2 Dataset: After the first round of training, the LoRA adapter weights are merged with the base model weights, resulting in an AI agent that can carry out most of the Round 1 training tasks correctly. Some errors remain, however, and human evaluators inspected the performance and identified the most typical errors. The top 5 explained around 87% of the errors. A detector for each of these categories was devised using a simple LLM-based classifier, along with hand-crafted hints that were observed to cut down the error rate to around 17% of the original. The dataset was initialized by taking the mistaken steps along with the corresponding hints.
   Round 2 Training: The teacher and student were initialized from the improved model from Round 1. A new LoRA adapter was added to the student, and training was again carried out for 20 epochs. Training samples were randomly selected from Round 1 or Round 2 training dataset with equal probability.
   Round 3+ Dataset and Training: Now human users started working with the improved AI agent resulting from merging the second LoRA adapter to the LLM. Their user interface allows them to interact with the agent and give feedback if the agent makes mistakes. This data is logged to provide further samples to the training dataset, and user feedback is used as hints to the agent. Nightly training runs result in continual improvement of the agent performance and allows the agent to adapt to changing requirements.
AI Help Desk Agent That Learns from Support Tickets.
   Use Case: An AI customer support agent that assists human agents and gradually learns how to handle issues independently.
   Training Mechanism: Starts as an observer, analyzing human responses. Over time, it suggests responses based on past ticket resolutions, receiving feedback from human agents before sending.
   Key Features: Continuous learning from case-by-case resolutions, confidence scoring for escalating complex cases, natural language processing for improving response quality.
AI Content Reviewer for Legal and Compliance Documents.
   Use Case: A compliance AI that reviews contracts, financial reports, or medical records, improving over time with human guidance.
   Training Mechanism: Initially, it highlights potential compliance issues based on predefined rules. Over time, it learns from expert corrections and identifies nuanced patterns.
   Key Features: Few-shot learning to adapt to company-specific guidelines, human-in-the-loop correction mechanism, contextual learning based on past corrections.
AI Code Review Assistant That Learns from Developer Feedback.
   Use Case: An AI-powered software development assistant that suggests bug fixes and code improvements based on best practices and team-specific coding standards.
   Training Mechanism: Initially provides generic code reviews based on pre-trained models. As developers correct its suggestions, it refines its recommendations based on company-specific coding conventions.
   Key Features: Incremental learning from code commits and pull request feedback, integration with version control systems, adaptive suggestions.

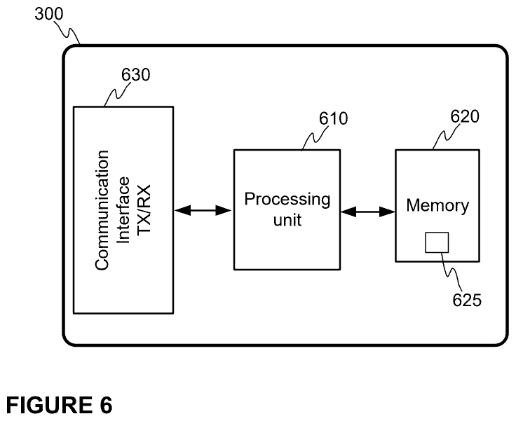

An example of such an apparatus configurable to implement the operation of the computing system 300 is schematically illustrated in FIG. 6. The computing system 300 may be configured to perform the method according to the disclosure as described with the examples in the foregoing description. Thus, the apparatus of FIG. 6 may be configured to perform an improvement of an operation of a first adaptive machine-learning model of an artificial intelligence agent by applying a second adaptive machine-learning model. For sake of clarity, it is worthwhile to mention that the block diagram of FIG. 6 depicts some components of an entity that may be employed to implement a functionality of the apparatus. The apparatus of FIG. 6 comprises a processor 610 and a memory 620. The memory 620 may store data, such as pieces of data as described, but also computer program code 625 causing the association in the described manner. The apparatus may further comprise a communication interface 630, such as a wireless communication interface or a communication interface for wired communication, or both to communicate with other entities as described. The communication interface 630 may thus comprise one or more modems, antennas, and any other hardware and software for enabling an execution of the communication e.g. under control of the processor 610. Furthermore, I/O (input/output) components may be arranged, together with the processor 610 and a portion of the computer program code 625, to provide a user interface for receiving input from a user, such as from a technician, and/or providing output to the user of the apparatus when necessary. In particular, the user I/O components may include user input means, such as one or more keys or buttons, a keyboard, a touchscreen, or a touchpad, etc. The user I/O components may include output means, such as a loudspeaker, a display, or a touchscreen. The components of the apparatus may be communicatively connected to each other via data bus that enables transfer of data and control information between the components.

The memory 620 and at least a portion of the computer program code 625 stored therein may further be arranged, with the processor 610, to cause the apparatus to perform at least a portion of a method as is described herein. The processor 610 may be configured to read from and write to the memory 620. Although the processor 610 is depicted as a respective single component, it may be implemented as respective one or more separate processing components. Similarly, although the memory 620 is depicted as a respective single component, it may be implemented as respective one or more separate components, some, or all of which may be integrated/removable and/or may provide permanent/semi-permanent/dynamic/cached storage.

The computer program code 625 may comprise computer-executable instructions that implement functions that correspond to steps implemented in the method when loaded into the processor 610 of the respective computing system 300. As an example, the computer program code 625 may include a computer program consisting of one or more sequences of one or more instructions. The processor 610 is able to load and execute the computer program by reading the one or more sequences of one or more instructions included therein from the memory 620. The one or more sequences of one or more instructions may be configured to, when executed by the processor 610, cause the apparatus, such as a computer, to perform a method as described. Hence, the apparatus may comprise at least one processor 610 and at least one memory 620 including the computer program code 625 for one or more programs, the at least one memory 620 and the computer program code 625 configured to, with the at least one processor 610, cause the apparatus implementing the computing system 300 to perform the method. For sake of completeness, it is worthwhile to mention that at least one portion of the computer program code 625 may correspond to AI agent and the first and the second adaptive machine-learning model thereof.

The computer program code 625, or at least some portion of it, may be provided e.g. a computer program product comprising at least one computer-readable non-transitory medium having the computer program code 625 stored thereon, which computer program code 625, when executed by the processor 610 causes the apparatus to perform the method. The computer-readable non-transitory medium may comprise a memory device or a record medium, such as a CD-ROM, a DVD, a Blu-ray disc, or another article of manufacture that tangibly embodies the computer program. As another example, the computer program may be provided as a signal configured to reliably transfer the computer program.

Still further, the computer program code 625 may comprise a proprietary application, such as computer program code for causing an execution of the method in the manner as described in the description herein.

Any of the programmed functions mentioned may also be performed in firmware or hardware adapted to or programmed to perform the necessary tasks.

For sake of completeness it is worthwhile to mention that the entity performing the method in the role of the computing system 300 may also be implemented with a plurality of apparatuses, such as the one schematically illustrated in FIG. 6, as a distributed computing environment corresponding to a control system. For example, one of the apparatuses may be communicatively connected with the other apparatuses, and e.g. share the data of the method, to cause another apparatus to perform at least one other portion of the method. As a result, the method performed in the distributed computing environment generates the control signal indicative of the assignment of the responsibility as described.

As derivable from above the disclosure relates to a distillation approach for training AI agents, such as LLM agents, without the need for task demonstrations. Through self-distillation, the AI agent learns to follow task guidelines without being reminded of them at inference time. In a second training stage, any remaining issues can be corrected through efficient use of human feedback: only one concise description of the problem and one hint designed to encourage the agent to avoid this mistake in the future are needed to address and fix problems. The application of the disclosure is especially suitable in generating AI agents for making a computer to operate in specific manner in sequential tasks/operations in order to assist the user of the computer in daily operations. In other words, the AI agent is configured to generate instructions to operate the computer.

The advantage of the present disclosure compared to prior art solutions is that it enables an introduction of an operative AI agent for its task with reduced computing resources. In general, the application of the prior art solutions even lead to degrading performance of the AI agent under training due to that the prompts become too heavy to handle and internalized.

The specific examples provided in the description given above should not be construed as limiting the applicability and/or the interpretation of the appended claims. Lists and groups of examples provided in the description given above are not exhaustive unless otherwise explicitly stated.

What is claimed is:

1. A computer-implemented method for improving an operation of a first adaptive machine-learning model of an artificial intelligence agent by applying a second adaptive machine-learning model with at least one dataset comprising at least one sample, the method comprises:
inputting at least one hint as a part of at least one sample in the at least one dataset to the second adaptive machine-learning model, the at least one hint corresponding to data causing the artificial intelligence agent to improve in its task,
generating a target to an output of the first adaptive machine-learning model of the artificial intelligence agent by applying the at least one hint in an execution of the task with the second adaptive machine-learning model,
training the first adaptive machine-learning model by applying the target generated by the second adaptive machine-learning model.

2. The computer-implemented method according to claim 1, wherein the at least one hint is generated through analyzing an operation of the first adaptive machine-learning model of the artificial intelligence agent in its task.

3. The computer-implemented method according to claim 1, wherein the at least one hint defines at least one instruction to improve the operation of the first adaptive machine-learning model of the artificial intelligence agent in its task.

4. The computer-implemented method according to claim 1, wherein the at least one hint is generated by at least one of: a human operator and a computing system.

5. The computer-implemented method according to claim 1, wherein the target to the output of the first adaptive machine-learning model of the artificial intelligence based agent is defined with a training data for the first adaptive machine-learning model.

6. The computer-implemented method according to claim 1, wherein the second adaptive machine-learning model is derived from the first adaptive machine-learning model.

7. The computer-implemented method according to claim 6, wherein the first adaptive machine-learning model and the second adaptive machine-learning model are provided with same weights in an initial stage of improving the operation of the first adaptive machine-learning model.

8. The computer-implemented method according to claim 6, wherein the second adaptive machine-learning model is derived from the first adaptive machine-learning model by setting weights of the second adaptive machine-learning model to correspond to floating averages of the respective weights of the first adaptive machine-learning model.

9. The computer-implemented method according to claim 7, wherein the second adaptive machine-learning model is derived from the first adaptive machine-learning model by setting weights of the second adaptive machine-learning model to correspond to floating averages of the respective weights of the first adaptive machine-learning model.

10. The computer-implemented method according to claim 1, wherein the first adaptive machine-learning model is provided with one or more selected portions of the at least one hint input to the second adaptive machine-learning model during the improvement of the operation of the first adaptive machine-learning model of the artificial intelligence.

11. The computer-implemented method according to claim 1, wherein the first adaptive machine-learning model and the second adaptive machine-learning model are provided with a same prompt in the at least one sample of the at least one dataset.

12. The computer-implemented method according to claim 1, wherein the input of the first adaptive machine-learning model is modified by one of: redefining the at least one hint in another manner; adding distractors to the prompt in the at least one sample of the at least dataset.

13. The computer-implemented method according to claim 1, wherein at least the second adaptive machine-learning model is requested, with the prompt, to reformulate a specific subject based on their current operative state.

14. The computer-implemented method according to claim 1, wherein the artificial intelligence agent is configured to generate instructions to a computer in relation to control an operation of the computer.

15. The computer-implemented method according to claim 14, wherein the instructions are defined to generate sequential operations of the computer.

16. A computing system comprising at least one hardware processor adapted to perform the method of claim 1.

17. A computer program comprising instructions which, when the program is executed by a computer comprising at least one hardware processor, causes the computer to carry out the method of claim 1.
